(19) United States
(12) Patent Application Publication
(10) Pub. No.: US 2020/0184893 A1
(43) Pub. Date: Jun. 11, 2020

(54) PIXEL CIRCUIT, DRIVE METHOD, ELECTROLUMINESCENT LIGHT EMITTING DISPLAY PANEL, AND DISPLAY APPARATUS

(71) Applicant: BOE Technology Group Co., Ltd., Beijing (CN)

(72) Inventor: Tian DONG, Beijing (CN)

(21) Appl. No.: 16/617,565

(22) PCT Filed: Nov. 27, 2018
(86) PCT No.: PCT/CN2018/117758

§ 371 Date: Nov. 27, 2019

(30) Foreign Application Priority Data
Jan. 11, 2018 (CN) 201810026813.6

(51) Int. Cl. G09G 3/3258

(52) U.S. Cl. CPC G09G 3/3258; G09G 2310/062; G09G 2320/0233; G09G 2300/0861; G09G 2310/0278

(57) ABSTRACT

A pixel circuit, a drive method, an electroluminescent light emitting display panel, and a display apparatus, the pixel circuit comprising: a light emitting device; a drive transistor is configured to generate drive current during light emitting phase to drive the light emitting device to emit light; a gate electrode of drive transistor is coupled to a capacitance circuit and a data write circuit, a first electrode of drive transistor is coupled to a reset circuit, and a second electrode of drive transistor is coupled to the reset circuit and a first electrode of light emitting device; the capacitance circuit is configured to store voltage of gate electrode of drive transistor; the data write circuit is configured to provide data signal to the gate electrode of drive transistor during data write phase; the reset circuit is configured to reset the first electrode, the second electrode of drive transistor during reset phase.

The present application is a National Application No. PCT/CN2018/117758, filed on Nov. 27, 2018, which claims priority to Chinese Patent Application No. 201810026813.6, entitled “PIXEL CIRCUIT, DRIVE METHOD, ELECTROLUMINESCENT LIGHT EMITTING DISPLAY PANEL, AND DISPLAY APPARATUS”, filled to Patent Office of the People's Republic of China on Jan. 11, 2018, both of which are incorporated herein by reference in their entireties.

### FIELD

The disclosure relates to the technical field of display and in particular relates to a pixel circuit, a drive method, an electroluminescent light emitting display panel, and a display apparatus.

### BACKGROUND

An organic light emitting diode (OLED) is one of hotspots in the research field of flat panel displays nowadays, and compared with a liquid crystal display (LCD), an OLED display has the advantages such as low energy consumption, low production cost, self-illumination, wide viewing angle and high response speed. At present, the OLED display has begun to replace a traditional LCD display in the field of displays such as mobile phones, tablet personal computers and digital cameras. Different from the LCD of which the brightness is controlled by virtue of a stable voltage, the OLED is driven by a current and is required to be controlled by a stable current to emit light. Generally, a pixel circuit is arranged to drive the OLED to emit light.

### SUMMARY

Some embodiments of the disclosure provide a pixel circuit, including:

a light emitting device;

a drive transistor, configured to generate a drive current during a light emitting phase in order to drive the light emitting device to emit light; wherein a gate electrode of the drive transistor is respectively coupled to a capacitance circuit and a data write circuit, a first electrode of the drive transistor is coupled to a reset circuit, and a second electrode of the drive transistor is respectively coupled to the reset circuit and a first electrode of the light emitting device;

the capacitance circuit, configured to store the voltage of the gate electrode of the drive transistor;

the data write circuit, configured to provide a data signal to the gate electrode of the drive transistor during a data write phase;

and the reset circuit, configured to reset the first electrode and the second electrode of the drive transistor during a reset phase.

Alternatively, in some embodiments of the disclosure, the reset circuit is further coupled to the gate electrode of the drive transistor, is configured to reset the gate electrode of the drive transistor during the reset phase and is configured to compensate the threshold voltage of the drive transistor during a threshold compensation phase.

Alternatively, in some embodiments of the disclosure, the reset circuit includes a first switching transistor, a second switching transistor and a third switching transistor;

a gate electrode of the first switching transistor is coupled to a first scanning signal line, a first electrode of the first switching transistor is coupled to a first reference signal line, and a second electrode of the first switching transistor is coupled to the second electrode of the drive transistor;

a gate electrode of the second switching transistor is coupled to a second scanning signal line, a first electrode of the second switching transistor is coupled to a second reference signal line, and a second electrode of the second switching transistor is coupled to the first electrode of the drive transistor;

and a gate electrode of the third switching transistor is coupled to a third scanning signal line, a first electrode of the third switching transistor is coupled to a third reference signal line, and a second electrode of the third switching transistor is coupled to the gate electrode of the drive transistor.

Alternatively, in some embodiments of the disclosure, materials of active layers of the first switching transistor and the third switching transistor include a metal oxide semiconductor material;

and a material of an active layer of the second switching transistor includes a low temperature poly-silicon material.

Alternatively, in some embodiments of the disclosure, a signal of the first scanning signal line is the same as a signal of the third scanning signal line.

Alternatively, in some embodiments of the disclosure, a signal of the first reference signal line is the same as a signal of the third reference signal line.

Alternatively, in some embodiments of the disclosure, the capacitance circuit includes a storage capacitor and a voltage dividing capacitor:

the storage capacitor is coupled between the gate electrode and the first electrode of the drive transistor;

and the voltage dividing capacitor is coupled between the first electrode of the drive transistor and the second reference signal line.

Alternatively, in some embodiments of the disclosure, the data write circuit includes a fourth switching transistor;

a gate electrode of the fourth switching transistor is coupled to a fourth scanning signal line, a first electrode of the fourth switching transistor is coupled to a data signal line for receiving a data signal, and a second electrode of the fourth switching transistor is coupled to the gate electrode of the drive transistor.

Alternatively, in some embodiments of the disclosure, a material of an active layer of the fourth switching transistor includes a metal oxide semiconductor material.

Alternatively, in some embodiments of the disclosure, the pixel circuit further includes a light emitting control circuit; the second electrode of the drive transistor and the reset circuit are respectively coupled to the first electrode of the light emitting device by the light emitting control circuit; wherein the light emitting control circuit is used for controlling the second electrode of the drive transistor and the first electrode of the light emitting device to be turned on or off.

Alternatively, in some embodiments of the disclosure, the light emitting control circuit includes a fifth switching transistor; a gate electrode of the fifth switching transistor is coupled to a light emitting control signal line, a first electrode of the fifth switching transistor is coupled to the second electrode of the drive transistor, and a second electrode of the fifth switching transistor is coupled to the first electrode of the light emitting device.

Alternatively, in some embodiments of the disclosure, a material of an active layer of the fifth switching transistor includes a low temperature poly-silicon material.

Alternatively, in some embodiments of the disclosure, a signal of the light emitting control signal line is the same as a signal of the second scanning signal line.

Alternatively, in some embodiments of the disclosure, a material of an active layer of the drive transistor includes a low temperature poly-silicon material.

Accordingly, some embodiments of the disclosure further provides a pixel circuit, including:

a light emitting device;

a first switching transistor, a gate electrode of the first switching transistor being coupled to a first scanning signal line, a first electrode of the first switching transistor being coupled to a first reference signal line, and a second electrode of the first switching transistor being coupled to a second electrode of a drive transistor;

a second switching transistor, a gate electrode of the second switching transistor being coupled to a second scanning signal line, a first electrode of the second switching transistor being coupled to a second reference signal line, and a second electrode of the second switching transistor being coupled to a first electrode of the drive transistor;

a third switching transistor, a gate electrode of the third switching transistor being coupled to a third scanning signal line, a first electrode of the third switching transistor being coupled to a third reference signal line, and a second electrode of the third switching transistor being coupled to a gate electrode of the drive transistor;

a fourth switching transistor, a gate electrode of the fourth switching transistor being coupled to a fourth scanning signal line, a first electrode of the fourth switching transistor being coupled to a data signal line, and a second electrode of the fourth switching transistor being coupled to the gate electrode of the drive transistor;

a fifth switching transistor, a gate electrode of the fifth switching transistor being coupled to a light emitting control signal line, a first electrode of the fifth switching transistor being respectively coupled to the second electrode of the drive transistor and the second electrode of the first switching transistor, and a second electrode of the fifth switching transistor being coupled to a first electrode of the light emitting device;

a storage capacitor, the storage capacitor being coupled between the gate electrode and the first electrode of the drive transistor;

and a voltage dividing capacitor, the voltage dividing capacitor being coupled between the first electrode of the drive transistor and the second reference signal line.

Alternatively, in some embodiments of the disclosure, materials of active layers of the first switching transistor, the third switching transistor and the fourth switching transistor include a metal oxide semiconductor material;

and materials of active layers of the second switching transistor, the fifth switching transistor and the drive transistor include a low temperature poly-silicon material.

Alternatively, in some embodiments of the disclosure, a signal of the first scanning signal line is the same as a signal of the third scanning signal line.

Alternatively, in some embodiments of the disclosure, a signal of the first reference signal line is the same as a signal of the third reference signal line.

Alternatively, in some embodiments of the disclosure, a signal of the light emitting control signal line is the same as a signal of the second scanning signal line.

Accordingly, some embodiments of the disclosure provides an electroluminescent light emitting display panel, including a pixel circuit, a data signal line, a first scanning signal line, a second scanning signal line, a third scanning signal line, a fourth scanning signal line, a light emitting control signal line, a first reference signal line, a second reference signal line and a third reference signal line;

the pixel circuit includes a first switching transistor, a second switching transistor, a third switching transistor, a fourth switching transistor, a fifth switching transistor, a drive transistor, a storage capacitor, a voltage dividing capacitor and a light emitting device; wherein

a gate electrode of the first switching transistor is coupled to the first scanning signal line applying the current corresponding signal to the gate electrode of the first switching transistor, a first electrode of the first switching transistor is coupled to the first reference signal line, and a second electrode of the first switching transistor is coupled to a second electrode of the drive transistor;

a gate electrode of the second switching transistor is coupled to the second scanning signal line applying the current corresponding signal to the gate electrode of the second switching transistor, a first electrode of the second switching transistor is coupled to the second reference signal line, and a second electrode of the second switching transistor is coupled to a first electrode of the drive transistor;

a gate electrode of the third switching transistor is coupled to the third scanning signal line applying the current corresponding signal to the gate electrode of the third switching transistor, a first electrode of the third switching transistor is coupled to the third reference signal line, and a second electrode of the third switching transistor is coupled to a gate electrode of the drive transistor;

a gate electrode of the fourth switching transistor is coupled to the fourth scanning signal line applying the current corresponding signal to the gate electrode of the fourth switching transistor, a first electrode of the fourth switching transistor is coupled to the data signal line applying the current corresponding signal to the first electrode of the fourth switching transistor, and a second electrode of the fourth switching transistor is coupled to the gate electrode of the drive transistor;

a gate electrode of the fifth switching transistor is coupled to the light emitting control signal line applying the current corresponding signal to the gate electrode of the fifth switching transistor, a first electrode of the fifth switching transistor is respectively coupled to the second electrode of the drive transistor and the second electrode of the first switching transistor, and a second electrode of the fifth switching transistor is coupled to a first electrode of the light emitting device;

the storage capacitor is coupled between the gate electrode and the first electrode of the drive transistor;

and the voltage dividing capacitor is coupled between the first electrode of the drive transistor and the second reference signal line.

Alternatively, in some embodiments of the disclosure, signals of the first scanning signal line and the third scanning signal line coupled to the same pixel circuit are the same.

Alternatively, in some embodiments of the disclosure, a signal of the first reference signal line is the same as a signal of the third reference signal line.

Alternatively, in some embodiments of the disclosure, signals of the light emitting control signal line and the second scanning signal line coupled to the same pixel circuit are the same.

Alternatively, some embodiments of the disclosure provides a display apparatus including the electroluminescent light emitting display panel according to any one of claims 20-23.

Accordingly, some embodiments of the disclosure provides a drive method of the pixel circuit, including:

resetting the first electrode and the second electrode of the drive transistor by the reset circuit during a reset phase;

providing the data signal to the gate electrode of the drive transistor by the data write circuit during a data write phase;

and storing the voltage of the gate electrode of the drive transistor by the capacitance circuit, and generating the drive current by the drive transistor in order to drive the light emitting device to emit light during a light emitting phase.

Alternatively, in some embodiments of the disclosure, the method further includes: resetting the gate electrode of the drive transistor by the reset circuit during the reset phase;

and after the reset phase and before the data write phase, the method further includes: compensating the threshold voltage of the drive transistor by the reset circuit during a threshold compensation phase.

Alternatively, in some embodiments of the disclosure, during the reset phase, the first switching transistor in the reset circuit is controlled to be turned on and the signal of the first reference signal line is controlled to be provided to the second electrode of the drive transistor, the second switching transistor is controlled to be turned on and the signal of the second reference signal line is controlled to be provided to the first electrode of the drive transistor, the third switching transistor is controlled to be turned on and the signal of the third reference signal line is controlled to be provided to the gate electrode of the drive transistor;

and during the threshold compensation phase, the second switching transistor in the reset circuit is controlled to be turned off, the first switching transistor is controlled to be turned on and the signal of the first reference signal line is controlled to be provided to the second electrode of the drive transistor, the third switching transistor is controlled to be turned on and the signal of the third reference signal line is controlled to be provided to the gate electrode of the drive transistor; and the drive transistor is turned on to perform threshold compensation.

Alternatively, in some embodiments of the disclosure, the method further includes: turning on the second electrode of the drive transistor and the first electrode of the light emitting device by the light emitting control circuit during the reset phase and the light emitting phase.

### BRIEF DESCRIPTION OF THE DRAWINGS

FIG. 1 is a first structural schematic diagram of a pixel circuit provided by some embodiments of the disclosure;

FIG. 2 is a second structural schematic diagram of the pixel circuit provided by some embodiments of the disclosure;

FIG. 3a is a first specific structural schematic diagram of the pixel circuit provided by some embodiments of the disclosure;

FIG. 3b is a second specific structural schematic diagram of the pixel circuit provided by some embodiments of the disclosure;

FIG. 4a is a third specific structural schematic diagram of the pixel circuit provided by some embodiments of the disclosure;

FIG. 4b is a fourth specific structural schematic diagram of the pixel circuit provided by some embodiments of the disclosure;

FIG. 5a is a first circuit sequence diagram in some embodiments of the disclosure;

FIG. 5b is a second circuit sequence diagram in some embodiments of the disclosure;

FIG. 5c is a third circuit sequence diagram in some embodiments of the disclosure;

FIG. 5a is a fourth circuit sequence diagram in some embodiments of the disclosure;

FIG. 6 is a flow diagram of a drive method provided by some embodiments of the disclosure;

FIG. 7 is a first structural schematic diagram of an electroluminescent light emitting display panel provided by some embodiments of the disclosure;

FIG. 8 is a second structural schematic diagram of the electroluminescent light emitting display panel provided by some embodiments of the disclosure.

### DETAILED DESCRIPTION OF THE EMBODIMENTS

In order to make the objects, technical solutions and advantages of the disclosure clearer, detailed descriptions of a pixel circuit, a drive method, an electroluminescent light emitting display panel, and a display apparatus provided by some embodiments of the disclosure are explained in detail below in combination with accompanying drawings. It should be understood that the preferred embodiments described below merely intend to describe and explain the disclosure, rather than to limit the disclosure. Moreover, the embodiments in the application and features in the embodiments may be combined with each other under the condition that no conflicts exist.

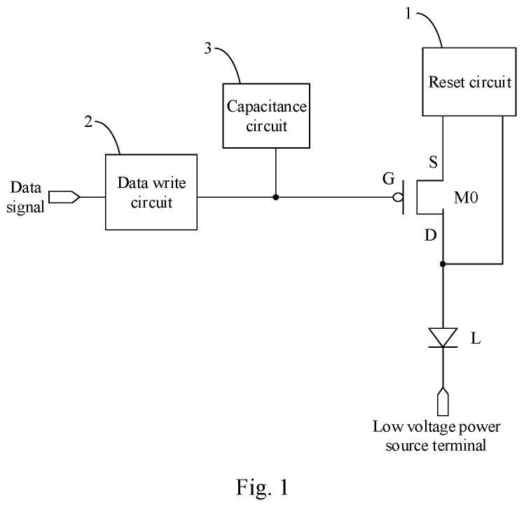

Some embodiments of the disclosure provide a pixel circuit, as shown in FIG. 1, including:

a light emitting device L;

a drive transistor M0, configured to generate a drive current during a light emitting phase in order to drive the light emitting device L to emit light; wherein a gate electrode G of the drive transistor M0 is respectively coupled to a capacitance circuit 3 and a data write circuit 2, a first electrode S of the drive transistor MO is coupled to a reset circuit 1, and a second electrode D of the drive transistor M0 is respectively coupled to the reset circuit 1 and a first electrode of the light emitting device L;

the capacitance circuit 3, configured to store the voltage of the gate electrode G of the drive transistor M0;

the data write circuit 2, configured to provide a data signal (Data) to the gate electrode G of the drive transistor M0 during a data write phase;

and the reset circuit 1, configured to reset the first electrode S and the second electrode D of the drive transistor M0 during a reset phase.

According to the pixel circuit provided by some embodiments of the disclosure, the first electrode and the second electrode of the drive transistor may be reset by the reset circuit during the reset phase, then, the data signal may be written into the gate electrode of the drive transistor by the data write circuit, and the drive current is generated by the drive transistor in order to drive the light emitting device to emit light. Thus, the voltage of the first electrode of the drive transistor may be set as a fixed voltage before the data signal is written every time, and the voltage of the second electrode of the drive transistor may be set as the fixed voltage, so that influences of the residual voltage of the previous frame on the light emission of the frame may be avoided, and furthermore, the light emitting uniformity of the display panel may be improved.

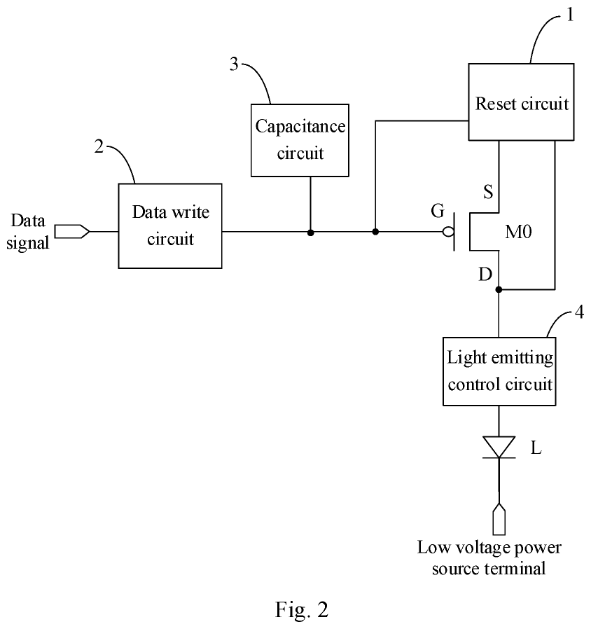

The characteristics such as the threshold voltage and migration rate of the drive transistor may be offset due to the action of a bias stress after the drive transistor drives the light emitting device to emit light for a period of time under a certain gray level. However, bias stresses generated when the drive transistor drives the light emitting device to emit light under different gray levels are different to result in different offsets of the characteristics of the drive transistor under different gray levels, and thus, a short-term residual image problem may appear due to a hysteresis effect during high and low gray level switched display. During specific implementation, in the pixel circuit provided by some embodiments of the disclosure, as shown in FIG. 2, the reset circuit 1 is further coupled to the gate electrode G of the drive transistor M0, is configured to reset the gate electrode G of the drive transistor M0 during the reset phase and is configured to compensate the threshold voltage of the drive transistor M0 during a threshold compensation phase. Thus, before the data signal of each frame is written, the voltage of the gate electrode G of the drive transistor M0 is reset, namely the voltage of the gate electrode G becomes a fixed voltage, in addition, the voltage of the first electrode S of the drive transistor MO becomes a fixed voltage, the voltage of the second electrode D of the drive transistor M0 becomes a fixed voltage, when the data signal Data is written every time, the gate electrode G of the drive transistor M0 is jumped by the same voltage, and the voltage of the first electrode S of the drive transistor M0 is jumped by the same voltage, so that the short-term residual image problem caused by the hysteresis effect may be relieved.

The disclosure is described in detail below in combination with a specific embodiment. It should be explained that some embodiments intends to better explain the disclosure, rather than to limit the disclosure.

A transistor with an active layer made of a low temperature poly-silicon (LTPS) material is high in migration rate and may be made thinner and smaller as well as lower in power consumption, and during specific implementation, the material of the active layer of the drive transistor may include the low temperature poly-silicon material.

Alternatively, during specific implementation, in the pixel circuit provided by some embodiments of the disclosure, as shown in FIG. 1 to FIG. 4b, the drive transistor M0 may be a P-type transistor; wherein the first electrode S of the drive transistor M0 is used as a source electrode of the drive transistor M0, and the second electrode D of the drive transistor M0 is used as a drain electrode of the drive transistor M0. Moreover, the current flows from the source electrode to the drain electrode of the drive transistor M0 when the drive transistor M0 is in a saturated state.

During specific implementation, in the pixel circuit provided by some embodiments of the disclosure, as shown in FIG. 1 to FIG. 4b, the second electrode of the light emitting device L is coupled to a low voltage power source terminal (ELVSS). The voltage of the low voltage power source terminal ELVSS is generally grounded or is a negative value, and the specific voltage value of the low voltage power source terminal ELVSS needs to be designed and determined according to an actual application environment, but is not limited herein.

During specific implementation, in the pixel circuit provided by some embodiments of the disclosure, the light emitting device may be an electroluminescent light emitting diode, wherein the anode of the electroluminescent light emitting diode is the first electrode of the light emitting device, and the cathode of the electroluminescent light emitting diode is the second electrode of the light emitting device, moreover, the light emitting device achieves light emission under the action of the current generated when the drive transistor is in the saturated state. In addition, a common light emitting device has a light emitting threshold voltage V_{L} and emits light when the voltage difference of two electrodes of the light emitting device is greater than or equal to the light emitting threshold voltage VL. Wherein the electroluminescent light emitting diode may include an organic light emitting diode or a quantum dot light emitting diode which are not limited herein.

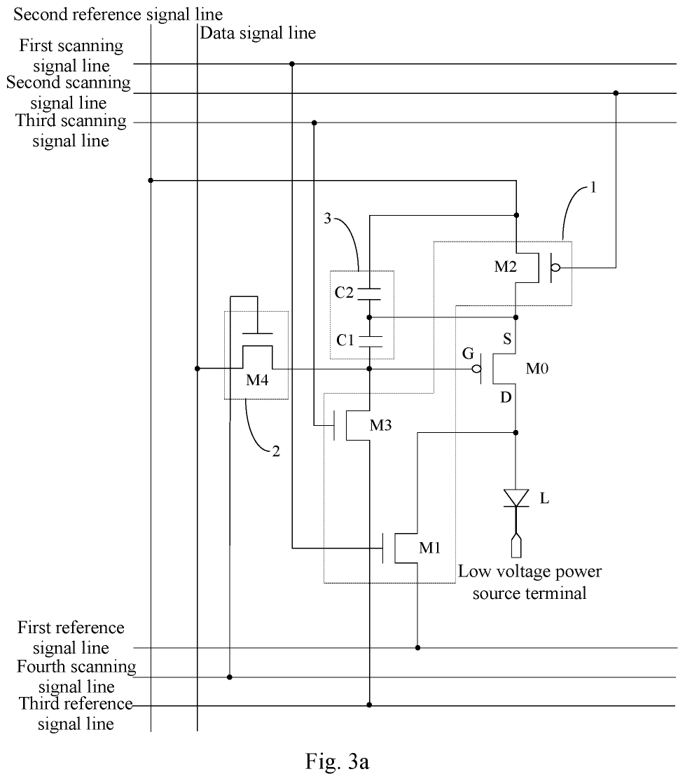

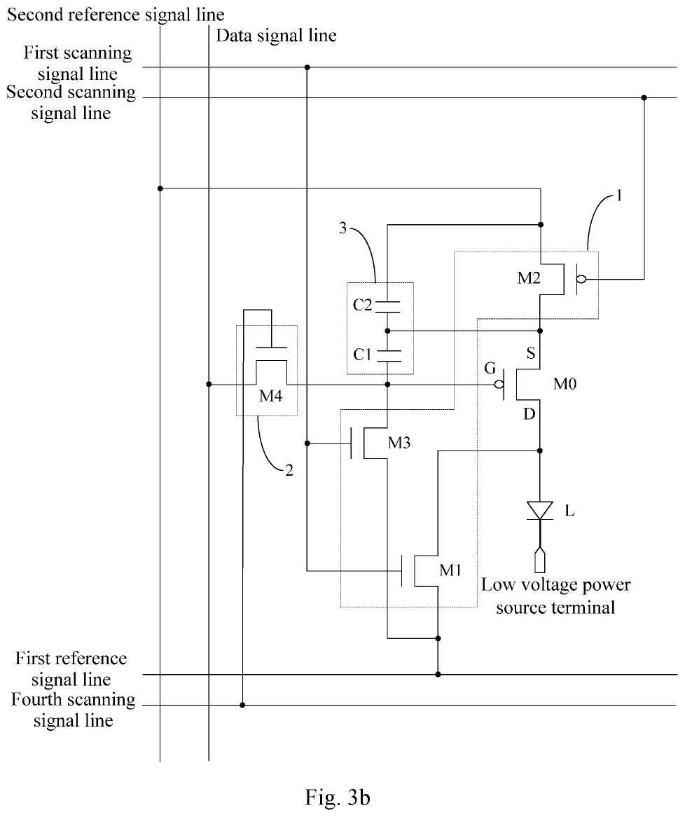

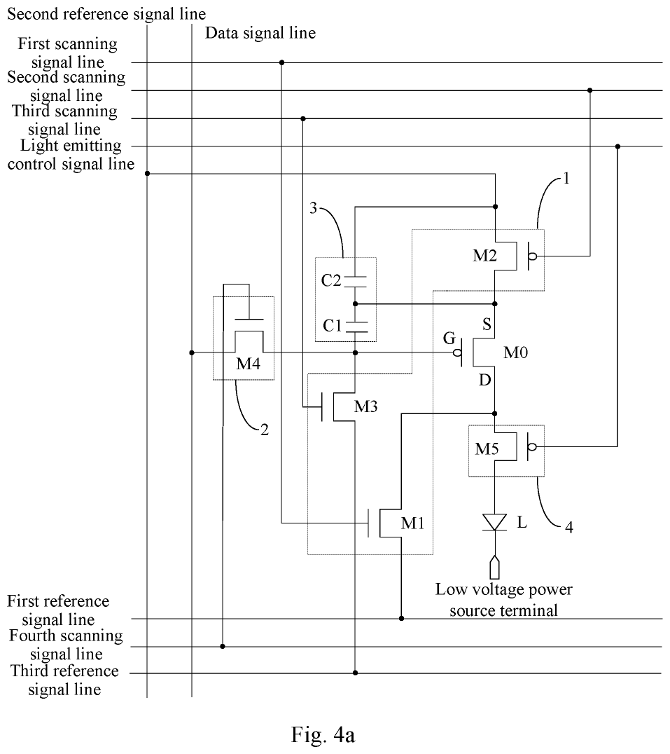

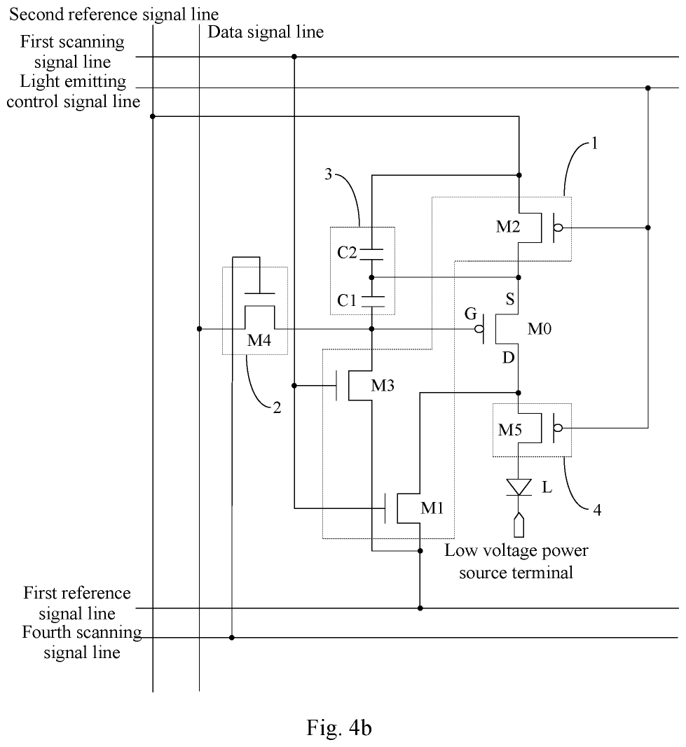

During specific implementation, in the pixel circuit provided by some embodiments of the disclosure, as shown in FIG. 3a to FIG. 4b, the data write circuit 2 may include a fourth switching transistor M4; wherein a gate electrode of the fourth switching transistor M4 is coupled to a fourth scanning signal line (Scan4), a first electrode of the fourth switching transistor M4 is coupled to a data signal line (DATA) for receiving a data signal, and a second electrode of the fourth switching transistor M4 is coupled to the gate electrode G of the drive transistor M0.

During specific implementation, in the pixel circuit provided by some embodiments of the disclosure, the fourth switching transistor is in a turn-on state under the control of a signal of the fourth scanning signal line during the data write phase, so that the data signal of the data signal line may be written into the gate electrode of the drive transistor.

The leakage current of a transistor with an active layer made of a metal oxide semiconductor material is generally relatively small, in order to reduce the leakage current, during specific implementation, in the pixel circuit provided by some embodiments of the disclosure, the material of the active layer of the fourth switching transistor may include the metal oxide semiconductor material such as IGZO (Indium Gallium Zinc Oxide), of course, the material of the active layer of the fourth switching transistor may also be other metal oxide semiconductor materials which are not limited herein. Thus, a leakage current generated when the fourth switching transistor M4 is turned off may be reduced, so that the disturbance of the leakage current of the fourth switching transistor M4 to the drive transistor M0 may be favorably reduced when the light emitting device L emits light, and furthermore, the drive current, for driving the light emitting device to emit light, of the drive transistor M0 may be prevented from being affected.

The specific structure of the data write circuit in the pixel circuit provided by some embodiments of the disclosure is merely illustrated, and during specific implementation, the specific structure of the data write circuit is not limited to the structure provided by some embodiments of the disclosure, may also be other structures known by the skilled in the art, but is not limited herein.

During specific implementation, in the pixel circuit provided by some embodiments of the disclosure, as shown in FIG. 3a to FIG. 4b, the reset circuit 1 may include a first switching transistor M1, a second switching transistor M2 and a third switching transistor M3.

A gate electrode of the first switching transistor M1 is coupled to a first scanning signal line (Scan1), a first electrode of the first switching transistor M1 is coupled to a first reference signal line (Vref1), and a second electrode of the first switching transistor M1 is coupled to the second electrode D of the drive transistor M0.

A gate electrode of the second switching transistor M2 is coupled to a second scanning signal line (Scan2), a first electrode of the second switching transistor M2 is coupled to a second reference signal line (Vref2), and a second electrode of the second switching transistor M2 is coupled to the first electrode S of the drive transistor M0.

A gate electrode of the third switching transistor M3 is coupled to a third scanning signal line (Scan3), a first electrode of the third switching transistor M3 is coupled to a third reference signal line (Vref3), and a second electrode of the third switching transistor M3 is coupled to the gate electrode G of the drive transistor M0.

During specific implementation, in the pixel circuit provided by some embodiments of the disclosure, the first switching transistor is in a turn-on state under the control of a signal of the first scanning signal line during the reset phase, so that a signal of the first reference signal line may be provided to the second electrode of the drive transistor, and furthermore, the second electrode of the drive transistor is reset during the reset phase. The second switching transistor is in a turn-on state under the control of a signal of the second scanning signal line during the reset phase, so that a signal of the second reference signal line may be provided to the first electrode of the drive transistor, and furthermore, the first electrode of the drive transistor is reset during the reset phase. The third switching transistor is in a turn-on state under the control of a signal of the third scanning signal line during the reset phase, so that a signal of the third reference signal line may be provided to the gate electrode of the drive transistor, and furthermore, the gate electrode of the drive transistor is reset during the reset phase. The third switching transistor is in a turn-on state under the control of the signal of the third scanning signal line during the threshold compensation phase, so that the signal of the third reference signal line may be provided to the gate electrode of the drive transistor; the first switching transistor is in a turn-on state under the control of the signal of the first scanning signal line during the threshold compensation phase, so that the signal of the first reference signal line may be provided to the second electrode of the drive transistor; and the drive transistor is turned on during the threshold compensation phase so as to realize threshold compensation.

During specific implementation, in the pixel circuit provided by some embodiments of the disclosure, a material of an active layer of the first switching transistor may include a metal oxide semiconductor. Thus, a leakage current generated when the first switching transistor is turned off may be reduced, so that the disturbance of the leakage current of the first switching transistor to the drive transistor may be favorably reduced when the light emitting device emits light, and furthermore, the drive current, for driving the light emitting device to emit light, of the drive transistor may be prevented from being affected.

During specific implementation, in the pixel circuit provided by some embodiments of the disclosure, a material of an active layer of the third switching transistor may include a metal oxide semiconductor material. Thus, a leakage current generated when the third switching transistor is turned off may be reduced, so that the disturbance of the leakage current of the third switching transistor to the drive transistor may be favorably reduced when the light emitting device emits light, and furthermore, the drive current, for driving the light emitting device to emit light, of the drive transistor may be prevented from being affected.

During specific implementation, in the pixel circuit provided by some embodiments of the disclosure, a material of an active layer of the second switching transistor may include low-temperature poly-silicon material, and thus, the second switching transistor may be high in migration rate and may be made thinner and smaller as well as lower in power consumption.

In order to reduce the arrangment and number of the signal lines and save the line arrangment space, during specific implementation, in the pixel circuit provided by some embodiments of the disclosure, the signals of the first reference signal line and the third reference signal line may be set to be the same. Alternatively, the first reference signal line and the third reference signal line are enabled to be set as the same signal line. Optionally, as shown in FIG. 3b and FIG. 4b, both the first electrode of the first switching transistor M1 and the first electrode of the third switching transistor M3 may be coupled to the first reference signal line Vref1. Of course, both the first electrode of the first switching transistor and the first electrode of the third switching transistor may also be coupled to the third reference signal line, there are no limits herein.

In order to reduce the arrangment and number of the signal lines and save the line arrangment space, during specific implementation, in the pixel circuit provided by some embodiments of the disclosure, the signals of the first scanning signal line and the third scanning signal line may be set to be the same. Alternatively, the first scanning signal line and the third scanning signal line are enabled to be set as the same signal line. Optionally, as shown in FIG. 3b and FIG. 4b, both the gate electrode of the first switching transistor M1 and the gate electrode of the third switching transistor M3 may be coupled to the first scanning signal line Scan1, at the moment, the first switching transistor M1 and the third switching transistor M3 are the same type of transistor, namely an N-type transistor, there are no limits herein. Of course, both the gate electrode of the first switching transistor and the gate electrode of the third switching transistor may also be coupled to the third scanning signal line, there are no limits herein.

In order to reduce the arrangment and number of the signal lines and save the line arrangment space, during specific implementation, in the pixel circuit provided by some embodiments of the disclosure, the signals of the first scanning signal line and the third scanning signal line are set to be the same, and the signal of the first reference signal line and the signal of the third reference signal line are set to be the same. Specifically, as shown in FIG. 3b and FIG. 4b, both the first electrode of the first switching transistor M1 and the first electrode of the third switching transistor M3 may be coupled to the first reference signal line Vref1, and both the gate electrode of the first switching transistor M1 and the gate electrode of the third switching transistor M3 may also be coupled to the first scanning signal line Scan1.

During specific implementation, in the pixel circuit provided by some embodiments of the disclosure, a voltage V_{ref2} of the signal of the second reference signal line is generally a positive value, for example, the signal of the second reference signal line may be a signal of a high voltage power source terminal ELVDD. A voltage V_{ref1} of the signal of the first reference signal line is preferably a negative value, and a voltage V_{ref3} of the signal of the third reference signal line is generally a negative value, wherein the voltage V_{ref1} of the first reference signal line and a voltage Vₛₛ of the low voltage power source terminal generally meet a formula: V_{ref1}-Vₛₛ<V_{L}. Moreover, the specific voltage value of the signal of the signal line needs to be designed and determined according to an actual application environment, but is not limited herein.

The specific structure of the reset circuit in the pixel circuit provided by some embodiments of the disclosure is merely illustrated, and during specific implementation, the specific structure of the reset circuit is not limited to the structure provided by some embodiments of the disclosure, may also be other structures known by the skilled in the art, but is not limited herein.

During specific implementation, in the pixel circuit provided by some embodiments of the disclosure, as shown in FIG. 3a to FIG. 4b, the capaciance circuit 3 may include a storage capacitor C1 and a voltage dividing capacitor C2:

the storage capacitor C1 is coupled between the gate electrode G and the first electrode S of the drive transistor M0;

and the voltage dividing capacitor C2 is coupled between the first electrode S of the drive transistor M0 and the second reference signal line Vref2.

During specific implementation, in the pixel circuit provided by some embodiments of the disclosure, the storage capacitor may keep the voltages of the gate electrode and the first electrode of the drive transistor stable, may charge or discharge under the actions of signals input to the gate electrode and the first electrode of the drive transistor and may also couple a variable voltage difference of the gate electrode of the drive transistor to the first electrode of the drive transistor when the first electrode of the drive transistor is in a floating state.

The specific structure of the capacitance circuit in the pixel circuit provided by some embodiments of the disclosure is merely illustrated, and during specific implementation, the specific structure of the capacitance circuit is not limited to the structure provided by some embodiments of the disclosure, may also be other structures known by the skilled in the art, but is not limited herein.

In order to avoid affecting performances of the light emitting device during the threshold compensation phase, during specific implementation, in the pixel circuit provided by some embodiments of the disclosure, as shown in FIG. 2, the pixel circuit may further include a light emitting control circuit 4; the second electrode D of the drive transistor M0 and the reset circuit 1 are respectively coupled to the first electrode of the light emitting device L by the light emitting control circuit 4; wherein the light emitting control circuit 4 is configured to control the second electrode D of the drive transistor M0 and the first electrode of the light emitting device L to be turned on or off. Thus, the light emitting device L may be reset during the reset phase, and the drive current generated by the drive transistor M0 may flow to the light emitting device L during the light emitting phase in order to drive the light emitting device L to emit light.

During specific implementation, in the pixel circuit provided by some embodiments of the disclosure, as shown in FIG. 4a and FIG. 4b, the light emitting control circuit 4 may include a fifth switching transistor M5;

a gate electrode of the fifth switching transistor M5 is coupled to a light emitting control signal line (EMIT), a first electrode of the fifth switching transistor M5 is respectively coupled to the second electrode D of the drive transistor M0 and the first electrode of the first switching transistor, and a second electrode of the fifth switching transistor M5 is coupled to the first electrode of the light emitting device L.

During specific implementation, in the pixel circuit provided by some embodiments of the disclosure, the fifth switching transistor may be in a turn-on state under the control of a signal of the light emitting control signal line during the reset phase, so that the second electrode of the drive transistor and the first electrode of the light emitting device are turned on, and furthermore, the light emitting device is reset. The fifth switching transistor may be in a turn-on state under the control of the signal of the light emitting control signal line during the light emitting phase, so that the second electrode of the drive transistor and the first electrode of the light emitting device are turned on, and furthermore, the drive current generated by the drive transistor is output to the light emitting device so as to drive the light emitting device to emit light.

During specific implementation, in the pixel circuit provided by some embodiments of the disclosure, a material of an active layer of the fifth switching transistor may include a low temperature poly-silicon material, so that the fifth switching transistor may be made thinner and smaller as well as lower in power consumption.

In order to further reduce the arrangment and number of the signal lines and save the line arrangment space, during specific implementation, in the pixel circuit provided by some embodiments of the disclosure, the signal of the light emitting control signal line and the signal of the second scanning signal line may be set to be the same. Alternatively, the light emitting control signal line and the second scanning signal line are set as the same signal line. Optionally, as shown in FIG. 4b, both the gate electrode of the second switching transistor M2 and the gate electrode of the fifth switching transistor M5 may be coupled to the light emitting control signal line EMIT. Of course, the gate electrode of the second switching transistor and the gate electrode of the fifth switching transistor may also be coupled to the second scanning signal line, there are no limits herein.

The specific structure of the light emitting control circuit in the pixel circuit provided by some embodiments of the disclosure is merely illustrated, and during specific implementation, the specific structure of the light emitting control circuit is not limited to the structure provided by some embodiments of the disclosure, may also be other structures known by the skilled in the art, but is not limited herein.

Generally, the active layer may be subjected to ion doping by adopting a doping process when the metal oxide semiconductor material or the low temperature poly-silicon material is adopted as the active layer, so that the type of the formed transistor is P-type or N-type. During specific implementation, in the pixel circuit provided by some embodiments of the disclosure, each of the switching transistors may be set as a P-type transistor or an N-type transistor according to an actual application environment, there are no limits herein.

Alternatively, during specific implementation, in the pixel circuit provided by some embodiments of the disclosure, as shown in FIG. 3a to FIG. 4b, the first switching transistor M1, the third switching transistor M3 and the fourth switching transistor M4 may be set as the N-type transistor, and the second switching transistor M2 and the fifth switching transistor may be set as the P-type transistor.

In order to further reduce the leakage current, the switching transistors may adopt double-gate structures. During specific implementation, the first switching transistor, the third switching transistor and the fourth switching transistor may be preferably set to be of the double-gate structures. Thus, the disturbance to the drive transistor may be reduced when the light emitting device emits light, and furthermore, the drive current, for driving the light emitting device to emit light, of the drive transistor may be prevented from being affected. Moreover, in the pixel circuit provided by some embodiments of the disclosure, any switching transistor may be set to be of the double-gate structure in view of reducing the leakage current, there are no limits herein.

Optionally, in the pixel circuit provided by some embodiments of the disclosure, the P-type transistor is turned on under the action of a low-potential signal and is turned off under the action of a high-potential signal; and the N-type transistor is turned on under the action of a high-potential signal and is turned off under the action of a low-potential signal.

Optionally, in the pixel circuit provided by some embodiments of the disclosure, the first electrode of each of the switching transistors may be used as a source electrode of the switching transistor, and the second electrode of each of the switching transistors may be used as a drain electrode of the switching transistor, or the first electrode of each of the switching transistors may be used as the drain electrode of the switching transistor, and the second electrode of each of the switching transistors may be used as the source electrode of the switching transistor, there are no specific differences herein.

Further, during specific implementation, in the pixel circuit provided by some embodiments of the disclosure, the materials of the active layers of all the first switching transistor, the third switching transistor and the fourth switching transistor may be set as the metal oxide semiconductor material, namely all the first switching transistor, the third switching transistor and the fourth switching transistor are set as oxide thin film transistors, and thus, the leakage currents of the first switching transistor, the third switching transistor and the fourth switching transistor may be relatively small. Moreover, a process for preparing the transistors by taking the metal oxide semiconductor material as the active layers may be the same as a process for preparing the oxide thin film transistors in the prior art, the descriptions thereof are omitted herein. The materials of the active layers of the second switching transistor, the fifth switching transistor and the drive transistor are set as the low temperature poly-silicon material, namely all the drive transistor, the second switching transitor and the fifth switching transistor are set as LTPS-type transistors, and thus, the second switching transistor, the fifth switching transistor and the drive transistor are relatively high in migration rate and may be made thinner and smaller as well as lower in power consumption. Moreover, a process for preparing the transistors by taking the low temperature poly-silicon as the active layers may be the same as a process for preparing the LTPS-type transistors in the prior art, the descriptions thereof are omitted herein. Thus, an LTPO pixel circuit is prepared by combining the two processes for preparing the transistors including the LTPS-type transistors and the oxide thin film transistors, so that the leakage current of the gate electrode of the drive transistor may be relatively small, and the power consumption may be relatively low. Therefore, if the pixel circuit is configured to be applied to an electroluminescent light emitting display panel, the display uniformity may be guaranteed when the display panel performs display by reducing the refresh frequency.

The working process of the pixel circuit provided by some embodiments of the disclosure is described below in combination with a circuit sequence diagram. In the description, 1 represents for a high potential, and 0 represents for a low potential. It should be explained that 1 and 0 are logic potentials which merely intend to better explain the specific working process of some embodiments of the disclosure instead of a specific voltage value.

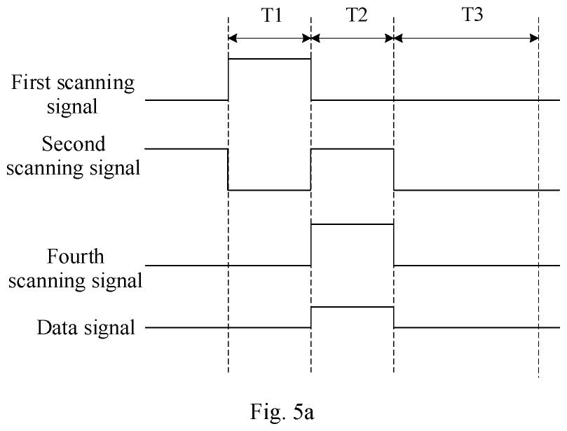

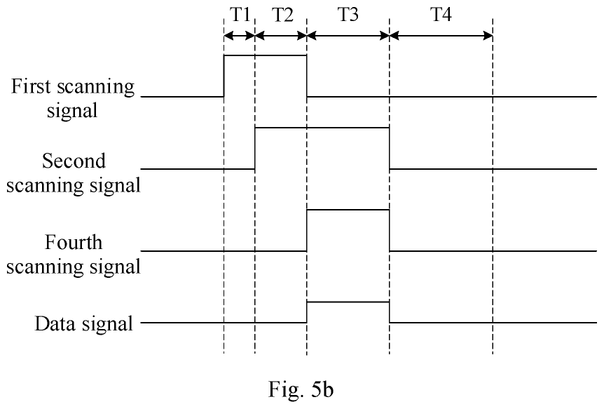

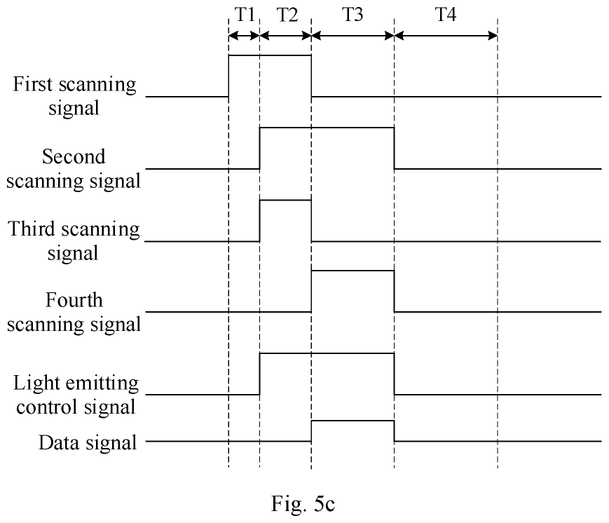

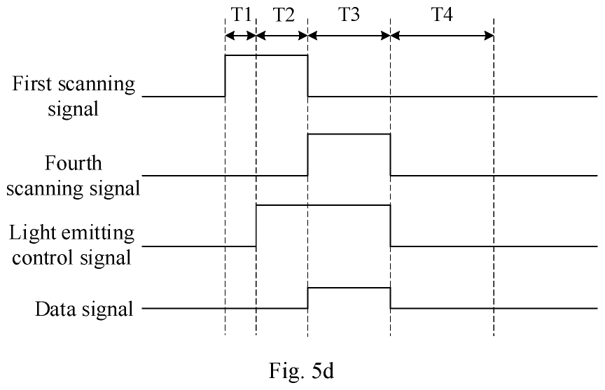

In some embodiments, with the pixel circuit as shown in FIG. 3b as an example, a corresponding input sequence diagram is shown as FIG. 5a. Optionally, total three phases including a reset phase T1, a data write phase T2 and a light emitting phase T3 in the input sequence diagram as shown in FIG. 5a are mainly selected.

During the reset phase T1,l a first scanning signal Scan1 is equal to 1, a second scanning signal Scan2 is equal to 0, and a fourth scanning signal Scan4 is equal to 0.

Since Scan1 is equal to 1, both the first switching transistor M1 and the third switching transistor M3 are turned on. The turn-on first switching transistor M1 provides the signal of the first reference signal line Vref1 to the second electrode D of the drive transistor M0, so that the second electrode D of the drive transistor M0 and the light emitting device L are reset, and furthermore, light emitting disturbance between two adjacent display frames is avoided. The turn-on third switching transistor M3 provides the signal of the first reference signal line Vref1 to the gate electrode G of the drive transistor M0, so that the gate electrode G of the drive transistor M0 is reset. Since Scan2 is equal to 0, the second switching transistor M2 is turned on to provide the signal of the second reference signal line Vref2 to the first electrode S of the drive transistor M0, so that the first electrode S of the drive transistor M0 is reset. Of course, the third switching transistor M3 may not be arranged when the reset circuit only resets the first electrode S and the second electrode D of the drive transistor M0. Since Scan4 is equal to 0, the fourth switching transistor M4 is turned off.

During the data write phase T2, Scan1 is equal to 0, Scan2 is equal to 1, and Scan4 is equal to 1.

Since Scan4 is equal to 1, the fourth switching transistor M4 is turned on to write the data signal of the data signal line DATA into the gate electrode G of the drive transistor M0, so that the voltage of the gate electrode G of the drive transistor M0 is a voltage V_{data} of the data signal and is stored by the storage capacitor C1. Since Scan1 is equal to 0, both the first switching transistor M1 and the third switching transistor M3 are turned off. Since Scan2 is equal to 1, the second switching transistor M2 is turned off.

During the light emitting phase T3, Scan1 is equal to 0, Scan2 is equal to 0, and Scan4 is equal to 0.

Since Scan2 is equal to 0, the second switching transistor M2 is turned on to provide the signal of the second reference signal line Vref2 to the first electrode S of the drive transistor M0, so that the voltage of the first electrode S of the drive transistor M0 is V_{ref2}. The drive transistor M0 generates the drive current IL under the control of the voltage V_{ref2} of the first electrode S and the voltage V_{data} of the gate electrode G of the drive transistor M0, and I_{L}=K[V_{data}−V_{ref2}−Vₜₕ]², so that the drive current IL drives the light emitting device L to emit light. Moreover, Vₜₕ is the threshold voltage of the drive transistor M0, K is a structural parameter, and

$$K = \frac{1}{2} {μ}_{n} {C}_{ox} \frac{W}{L} ,$$

μₙ represents for the migration rate of the drive transistor M0, Cₒₓ is the capacitance of a gate oxide layer on a unit area,

$$\frac{W}{L}$$

is the width-to-length ratio of the drive transistor M0, and the numerical values in the same structure are relatively stable and may be regarded as constants.

The first electrode and the second electrode of the drive transistor are reset during the reset phase, the data signal is written into the gate electrode of the drive transistor during the data write phase, and the drive transistor drives the light emitting device to emit light during the light emitting phase. Thus, the voltage of the first electrode of the drive transistor may be set as the fixed voltage before the data signal is written every time, and the voltage of the second electrode of the drive transistor may be set as the fixed voltage, so that influences of the residual voltage of the previous frame on the light emission of the frame may be avoided, and furthermore, the light emitting uniformity of the display panel may be improved.

The threshold voltage Vₜₕ of the drive transistor may drift due to technological processes and device aging, and thus, the drive current flowing through each light emitting device is affected by the drifting of Vₜₕ to change to result in display brightness non-uniformity, and furthermore, the display effect of the whole image is affected. Moreover, the drive current flowing through each light emitting device is related to the voltage V_{ref2} of the second reference signal line connected with the first electrode of the drive transistor, so that the drive current is further affected by the IR Drop of the second reference signal line to result in the phenomenon of brightness non-uniformity of the light emitting devices in different regions.

The specific implementation way for relieving the influences of the threshold voltage Vₜₕ of the drive transistor and IR Drop is described below by some embodiments. However, a reader should know that the specific implementation way is not limited herein.

In some other embodiments, with the pixel circuit as shown in FIG. 3b as an example, the working process of the pixel circuit is described, and an input sequence diagram corresponding to the pixel circuit is shown as FIG. 5b. Optionally, total four phases including a reset phase T1, a threshold compensation phase T2, a data write phase T3 and a light emitting phase T4 in the input sequence diagram as shown in FIG. 5b are mainly selected.

During the reset phase T1, Scan1 is equal to 1, Scan2 is equal to 0, and Scan4 is equal to 0.

Since Scan1 is equal to 1, both the first switching transistor M1 and the third switching transistor M3 are turned on. The turn-on first switching transistor M1 provides the signal of the first reference signal line Vref1 to the second electrode D of the drive transistor M0, so that the second electrode D of the drive transistor M0 and the light emitting device L are reset, and furthermore, light emitting disturbance between two adjacent display frames is avoided. The turn-on third switching transistor M3 provides the signal of the first reference signal line Vref1 to the gate electrode G of the drive transistor M0, so that the gate electrode G of the drive transistor M0 is reset. Since Scan2 is equal to 0, the second switching transistor M2 is turned on and provides the signal of the second reference signal line Vref2 to the first electrode S of the drive transistor M0, so that the first electrode S of the drive transistor M0 is reset, and the voltage V_{ref2} of the signal of the second reference signal line Vref2 is stored by the storage capacitor C1. Since Scan4 is equal to 0, the fourth switching transistor M4 is turned off

During the threshold compensation phase T2, Scan1 is equal to 1, Scan2 is equal to 1, and Scan4 is equal to 0.

Since Scan1 is equal to 1, both the first switching transistor M1 and the third switching transistor M3 are turned on. The turn-on third switching transistor M3 provides the signal of the first reference signal line Vref1 to the gate electrode of the drive transistor M0, so that the voltage of the gate electrode of the drive transistor M0 is V_{ref1}. The turn-on first switching transistor M1 provides the signal of the first reference signal line Vref1 to the second electrode D of the drive transistor M0, so that the voltage of the second electrode D of the drive transistor MO is V_{ref1}. Since Scan2 is equal to 1, the second switching transistor M2 is turned off. The storage capacitor C1 is capable of instantly keeping the voltage V_{ref2} of the first electrode of the drive transistor M0, so that the drive transistor M0 is turned on under the actions of V_{ref1} and V_{ref2}, and furthermore, the voltage of the first electrode S of the drive transistor M0 is discharged by the turn-on drive transistor M0 until the voltage of the first electrode S of the drive transistor M0 becomes V_{ref1}-Vₜₕ, at the moment, the drive transistor M0 is turned off, the threshold voltage Vₜₕ of the drive transistor M0 is written into the storage capacitor C1. Therefore, the compensation of the threshold voltage Vₜₕ of the drive transistor M0 is realized, and the compensation process may not affect the light emitting device L. Since Scan4 is equal to 0, the fourth switching transistor M4 is turned off.

During the data write phase T3, Scan1 is equal to 0, Scan2 is equal to 1, and Scan4 is equal to 1.

Since Scan4 is equal to 1, the fourth switching transistor M4 is turned on to provide the voltage V_{data} of the data signal to the gate electrode G of the drive transistor M0, so that the voltage of the gate electrode G of the drive transistor M0 becomes V_{data}. Since Scan2 is equal to 1, the second switching transistor M2 is turned off. Therefore, the first electrode S of the drive transistor M0 is in a floating state; due to the coupling effect of the storage capacitor C1 and the voltage dividing effect of the voltage dividing capacitor C2, the voltage of the first electrode S of the drive transistor M0 may become

$$( {V}_{data} - {V}_{ref 1} ) \frac{{c}_{1}}{{c}_{1} + {c}_{2}} + {V}_{ref 1} - {V}_{th} ;$$

wherein c1 represents for a capacitance value of the storage capacitor C1, and c2 represents for a capacitance value of the voltage dividing capacitor C2. Since Scan1 is equal to 0, both the first switching transistor M1 and the third switching transistor M3 are turned off.

During the light emitting phase T4, Scan1 is equal to 0, Scan2 is equal to 0, and Scan4 is equal to 0.

Since Scan2 is equal to 0, the second switching transistor M2 is turned on and provides the voltage V_{ref2} of the second reference signal line V ref2 to the first electrode S of the drive transistor M0, so that the voltage of the first electrode S of the drive transistor M0 is V_{ref2}. The voltage of the gate electrode G of the drive transistor M0 becomes

$$( {V}_{data} - {V}_{ref 1} ) \frac{{c}_{1}}{{c}_{1} + {c}_{2}} + {V}_{ref 2} - {V}_{th}$$

according to a charge conservation principle of charges of the storage capacitor C1 before and after jumping. Therefore, the drive transistor M0 is in a saturated state, and the drive transistor M0 generates the drive current I_{L} for driving the light emitting device L to emit light according to the characteristics of the current in the saturated state, I_{L} meets a formula:

$${I}_{L} = {K [ {V}_{gs} - {V}_{th} ]}^{2} = {[ ( {V}_{data} - {V}_{ref 1} ) \frac{{c}_{2}}{{c}_{1} + {c}_{2}} ]}^{2} ;$$

wherein V_{gs} is a gate-source voltage of the drive transistor M0, namely

$${V}_{gs} = ( {V}_{data} - {V}_{ref 1} ) \frac{{c}_{2}}{{c}_{1} + {c}_{2}} + {V}_{ref 2} + {V}_{th} - {V}_{ref 2} .$$

Moreover, K is a structural parameter, and

$$K = \frac{1}{2} {μ}_{n} {C}_{ox} \frac{W}{L} ,$$

μₙ represents for the migration rate of the drive transistor M0, Cₒₓ is the capacitance of a gate oxide layer on a unit area,

$$\frac{W}{L}$$

is the width-to-length ratio of the drive transistor M0, and the numerical values in the same structure are relatively stable and may be regarded as constants. The drive current I_{L} generated by the drive transistor M0 is provided to the light emitting device L in order to drive the light emitting device L to emit light. Known from the formula that the drive current I_{L} meets, the drive current I_{L}, for driving the light emitting device L to emit light, of the drive transistor M0 is only related to the voltage V_{data} of the data signal Data and the voltage V_{ref1} of the first reference signal line Vref1, but is unrelated to the threshold voltage Vₜₕ of the drive transistor M0 and the voltage V_{ref2} of the second reference signal line Vref2, and influences of threshold voltage Vₜₕ drifting and IR Drop caused by the technological processes and long-term operation of the drive transistor M0 on the drive current I_{L} for driving the light emitting device L may be overcome, so that the drive current IL for the light emitting device L is kept stable, and furthermore, the normal work of the light emitting device L is guaranteed.

The working process of the pixel circuit as shown in FIG. 3a may refer to that of the pixel circuit as shown in FIG. 3b, the descriptions thereof are omitted herein.

In some other embodiments, with the pixel circuit as shown in FIG. 4a as an example, the working process of the pixel circuit is described, and an input sequence diagram corresponding to the pixel circuit is shown as FIG. 5c. Optionally, total four phases including a reset phase T1, a threshold compensation phase T2, a data write phase T3 and a light emitting phase T4 in the input sequence diagram as shown in FIG. 5c are mainly selected.

During the reset phase T1, Scan1 is equal to 1, Scan2 is equal to 0, the third scanning signal Scan3 is equal to 0, Scan4 is equal to 0, and a light emitting control signal EM is equal to 0.

Since Scan1 is equal to 1, the first switching transistor M1 is turned on and provides the signal of the first reference signal line Vref1 to the second electrode D of the drive transistor M0, so that the second electrode D of the drive transistor M0 is set. Since Scan2 is equal to 0, the second switching transistor M2 is turned on and provides the signal of the second reference signal line Vref2 to the first electrode S of the drive transistor M0, so that the first electrode S of the drive transistor M0 is reset, and the voltage V_{ref2} of the signal of the second reference signal line Vref2 is stored by the storage capacitor C1. Since EM is equal to 0, the fifth switching transistor M5 is turned on, and the second electrode D of the drive transistor M0 and the first electrode of the light emitting device L are turned on, so that the signal of the first reference signal line Vref1 is provided to the light emitting device L, and the light emitting device L is reset, and furthermore, light emitting disturbance between two adjacent display frames is avoided. Since Scan4 is equal to 0, the fourth switching transistor M4 is turned off. Since Scan3 is equal to 0, the third switching transistor M3 is turned off.

During the threshold compensation phase T2, Scan1 is equal to 1, Scan2 is equal to 1, Scan3 is equal to 1, Scan4 is equal to 0, and EM is equal to 1.

Since Scan3 is equal to 1, the third switching transistor M3 is turned on and provides the signal of the third reference signal line Vref3 to the gate electrode G of the drive transistor M0, so that the voltage of the gate electrode of the drive transistor M0 is V_{ref3}. Since Scan1 is equal to 1, the first switching transistor M1 is turned on and provides the signal of the first reference signal line Vref1 to the second electrode D of the drive transistor M0, so that the voltage of the second electrode D of the drive transistor M0 is V_{ref1}. Since Scan2 is equal to 1, the second switching transistor M2 is turned off. Since EM is equal to 1, the fifth switching transistor M5 is turned off. The storage capacitor C1 is capable of instantly keeping the voltage V_{ref2} of the first electrode of the drive transistor M0, so that the drive transistor M0 is turned on under the actions of V_{ref3} and V_{ref2}, and furthermore, the voltage of the first electrode S of the drive transistor M0 is discharged by the turn-on drive transistor M0 until the voltage of the first electrode S of the drive transistor M0 becomes V_{ref3}-Vₜₕ, at the moment, the drive transistor M0 is turned off, the threshold voltage Vₜₕ of the drive transistor M0 is written into the storage capacitor C1. Therefore, the compensation of the threshold voltage Vₜₕ of the drive transistor M0 is realized, and the compensation process may not affect the light emitting device L. Since Scan4 is equal to 0, the fourth switching transistor M4 is turned off.

During the data write phase T3, Scan1 is equal to 0, Scan2 is equal to 1, Scan3 is equal to 0, Scan4 is equal to 1, and EM is equal to 1.

Since Scan4 is equal to 1, the fourth switching transistor M4 is turned on to provide the voltage V_{data} of the data signal to the gate electrode G of the drive transistor M0, so that the voltage of the gate electrode G of the drive transistor M0 becomes V_{data}. Since Scan2 is equal to 1, the second switching transistor M2 is turned off. Since Scan3 is equal to 0, the third switching transistor M3 is turned off. Therefore, the first electrode S of the drive transistor M0 is in a floating state; due to the coupling effect of the storage capacitor C1 and the voltage dividing effect of the voltage dividing capacitor C2, the voltage of the first electrode S of the drive transistor M0 may become

$$( {V}_{data} - {V}_{ref 3} ) \frac{{c}_{1}}{{c}_{1} + {c}_{2}} + {V}_{ref 3} - {V}_{th} ;$$

wherein c1 represents for a capacitance value of the storage capacitor C1, and c2 represents for a capacitance value of the voltage dividing capacitor C2. Since Scan1 is equal to 0, the first switching transistor M1 is turned off. Since EM is equal to 1, the fifth switching transistor M5 is turned off.

During the light emitting phase T4, Scan1 is equal to 0, Scan2 is equal to 0, Scan3 is equal to 0, Scan4 is equal to 0, and EM is equal to 0.

Since Scan2 is equal to 0, the second switching transistor M2 is turned on and provides the voltage V_{ref2} of the second reference signal line Vref2 to the first electrode S of the drive transistor M0, so that the voltage of the first electrode S of the drive transistor M0 is V_{ref2}. The voltage of the gate electrode G of the drive transistor M0 becomes

$$( {V}_{data} - {V}_{ref 3} ) \frac{{c}_{2}}{{c}_{1} + {c}_{2}} + {V}_{ref 2} + {V}_{th}$$

according to a charge conservation principle of charges of the storage capacitor C1 before and after jumping. Therefore, the drive transistor M0 is in a saturated state, and the drive transistor M0 generates the drive current I_{L} for driving the light emitting device L to emit light according to the characteristics of the current in the saturated state, I_{L} meets a formula:

$${I}_{L} = {K [ {V}_{gs} - {V}_{th} ]}^{2} = {K [ ( {V}_{data} - {V}_{ref 3} ) \frac{{c}_{2}}{{c}_{1} + {c}_{2}} ]}^{2} ;$$

wherein V_{gs} is a gate-source voltage of the drive transistor M0, namely

$${V}_{gs} = ( {V}_{data} - {V}_{ref 3} ) \frac{{c}_{2}}{{c}_{1} + {c}_{2}} + {V}_{ref 2} + {V}_{th} - {V}_{ref 2} .$$

Moreover, K is a structural parameter, and

$$K = \frac{1}{2} {μ}_{n} {C}_{ox} \frac{W}{L} ,$$

μₙ represents for the migration rate of the drive transistor M0, Cₒₓ is the capacitance of a gate oxide layer on a unit area,

$$\frac{W}{L}$$

is the width-to-length ratio of the drive transistor M0, and the numerical values in the same structure are relatively stable and may be regarded as constants. Since EM is equal to 0, the fifth switching transistor M5 is turned on, and the second electrode D of the drive transistor M0 and the light emitting device L are turned on, so that the drive current I_{L} generated by the drive transistor M0 is provided to the light emitting device L in order to drive the light emitting device L to emit light. Known from the formula that the drive current I_{L} meets, the drive current I_{L}, for driving the light emitting device L to emit light, of the drive transistor M0 is only related to the voltage V_{data} of the data signal Data and the voltage V_{ref1} of the first reference signal line Vref1, but is unrelated to the threshold voltage Vₜₕ of the drive transistor M0 and the voltage V_{ref2} of the second reference signal line Vref2, and influences of threshold voltage Vₜₕ drifting and IR Drop caused by the technological processes and long-term operation of the drive transistor M0 on the drive current I_{L} for driving the light emitting device L may be overcome, so that the drive current I_{L} for the light emitting device L is kept stable, and furthermore, the normal work of the light emitting device L is guaranteed.

Of course, during the reset phase, the signal of the third scanning signal line may also be changed to control the third switching transistor to be turned on, so that the gate electrode of the drive transistor is reset, and the voltage of the gate electrode of the drive transistor becomes Vref3. Thus, during the reset phase, the voltage of the gate electrode of the drive transistor is enabled to be V_{ref3}, the voltage of the second electrode of the drive transistor is enabled to be V_{ref1}, and the voltage of the first electrode of the drive transistor is enabled to be V_{ref2}, so that the three electrodes of the drive transistor may be simultaneously reset. During the threshold compensation phase, the voltage of the gate electrode of the drive transistor is enabled to be V_{ref3}, the voltage of the second electrode of the drive transistor is enabled to be V_{ref1}, and the voltage of the first electrode of the drive transistor becomes V_{ref3}-Vₜₕ, namely before a phase that each frame data is written, the gate electrode of the drive transistor may have the fixed voltage V_{ref3}, the first electrode of the drive transistor may have the fixed voltage V_{ref3}-Vₜₕ, and the second electrode of the drive transistor may have the fixed voltage V_{ref1}. Therefore, when the data signal is written every time, the gate electrode of the drive transistor may be jumped by the same fixed voltage, the voltage of the first electrode of the drive transistor may be jumped by the same fixed voltage, and furthermore, the short-term residual image problem caused by the hysteresis effect may be relieved.

In some other embodiments, with the pixel circuit as shown in FIG. 4b as an example, the working process of the pixel circuit is described, and an input sequence diagram corresponding to the pixel circuit is shown as FIG. 5d. Specifically, total four phases including a reset phase T1, a threshold compensation phase T2, a data write phase T3 and a light emitting phase T4 in the input sequence diagram as shown in FIG. 5d are mainly selected.

During the reset phase T1, Scan1 is equal to 1, Scan4 is equal to 0, and EM is equal to 0.

Since Scan1 is equal to 1, both the first switching transistor M1 and the third switching transistor M3 are turned on. The turn-on first switching transistor M1 provides the signal of the first reference signal line Vref1 to the second electrode D of the drive transistor M0, so that the second electrode D of the drive transistor M0 is reset. The turn-on third switching transistor M3 provides the signal of the first reference signal line Vref1 to the gate electrode G of the drive transistor M0, so that the gate electrode G of the drive transistor M0 is reset. Since EM is equal to 0, both the second switching transistor M2 and the fifth switching transistor M5 are turned on. The turn-on second switching transistor M2 provides the signal of the second reference signal line Vref2 to the first electrode S of the drive transistor M0, so that the first electrode S of the drive transistor M0 is reset, and the voltage V_{ref2} of the signal of the second reference signal line Vref2 is stored by the storage capacitor C1. The turn-on fifth switching transistor M5 turns on the second electrode D of the drive transistor M0 and the first electrode of the light emitting device L to provide the signal of the first reference signal line Vref1 to the light emitting device L, so that the light emitting device L is reset, and furthermore, light emitting disturbance between two adjacent display frames is avoided. Since Scan4 is equal to 0, the fourth switching transistor M4 is turned off.

During the threshold compensation phase T2, Scan1 is equal to 1, Scan4 is equal to 0, and EM is equal to 1.

Since Scan1 is equal to 1, both the first switching transistor M1 and the third switching transistor M3 are turned on. The turn-on third switching transistor M3 provides the signal of the first reference signal line Vref1 to the gate electrode of the drive transistor M0, so that the voltage of the gate electrode of the drive transistor M0 is Vref1. The turn-on first switching transistor M1 provides the signal of the first reference signal line Vref1 to the second electrode D of the drive transistor M0, so that the voltage of the second electrode D of the drive transistor M0 is V_{ref1}. Since EM is equal to 1, both the second switching transistor M2 and the fifth switching transistor M5 are turned off. The storage capacitor C1 is capable of instantly keeping the voltage V_{ref2} of the first electrode of the drive transistor M0, so that the drive transistor M0 is turned on under the actions of V_{ref1} and V_{ref2}, and furthermore, the voltage of the first electrode S of the drive transistor M0 is discharged by the turn-on drive transistor M0 until the voltage of the first electrode S of the drive transistor M0 becomes V_{ref1}-Vₜₕ, at the moment, the drive transistor M0 is turned off, the threshold voltage Vₜₕ of the drive transistor M0 is written into the storage capacitor C1. Therefore, the compensation of the threshold voltage Vₜₕ of the drive transistor M0 is realized, and the compensation process may not affect the light emitting device L. Since Scan4 is equal to 0, the fourth switching transistor M4 is turned off.

During the data write phase T3, Scan1 is equal to 0, Scan4 is equal to 1, and EM is equal to 1.

Since Scan4 is equal to 1, the fourth switching transistor M4 is turned on to provide the voltage V_{data} of the data signal Data to the gate electrode G of the drive transistor M0, so that the voltage of the gate electrode G of the drive transistor M0 becomes V_{data}. Since EM is equal to 1, both the second switching transistor M2 and the fifth switching transistor M5 are turned off. Therefore, the first electrode S of the drive transistor M0 is in a floating state; due to the coupling effect of the storage capacitor Cl and the voltage dividing effect of the voltage dividing capacitor C2, the voltage of the first electrode S of the drive transistor M0 may become

$$( {V}_{data} - {V}_{ref 1} ) \frac{{c}_{1}}{{c}_{1} + {c}_{2}} + {V}_{ref 1} - {V}_{th} ;$$

wherein c1 represents for a capacitance value of the storage capacitor C1, and c2 represents for a capacitance value of the voltage dividing capacitor C2. Since Scan1 is equal to 0, both the first switching transistor M1 and the third switching transistor M3 are turned off.

During the light emitting phase T4, Scan1 is equal to 0, Scan4 is equal to 0, and EM is equal to 0.

Since EM is equal to 0, both the second switching transistor M2 and the fifth switching transistor M5 are turned on. The turn-on second switching transistor M2 provides the voltage V_{ref2} of the second reference signal line Vref2 to the first electrode S of the drive transistor M0, so that the voltage of the first electrode S of the drive transistor M0 is V_{ref2}. The voltage of the gate electrode G of the drive transistor M0 becomes

$$( {V}_{data} - {V}_{ref 1} ) \frac{{c}_{2}}{{c}_{1} + {c}_{2}} + {V}_{ref 2} + {V}_{th}$$

according to a charge conservation principle of charges of the storage capacitor C1 before and after jumping. Therefore, the drive transistor M0 is in a saturated state, and the drive transistor M0 generates the drive current I_{L} for driving the light emitting device L to emit light according to the characteristics of the current in the saturated state, I_{L} meets a formula:

$${I}_{L} = {K [ {V}_{gs} - {V}_{th} ]}^{2} = {K [ ( {V}_{data} - {V}_{ref1} ) \frac{{c}_{2}}{{c}_{1} + {c}_{2}} ]}^{2} ;$$

wherein V_{gs} is a gate-source voltage of the drive transistor M0, namely

$${V}_{gs} = ( {V}_{data} - {V}_{ref 1} ) \frac{{c}_{2}}{{c}_{1} + {c}_{2}} + {V}_{ref 2} + {V}_{th} - {V}_{ref 2} .$$

Moreover, K is a structural parameter, and

$$K = \frac{1}{2} {μ}_{n} {C}_{ox} \frac{W}{L} ,$$

μₙ to represents for the migration rate of the drive transistor M0, Cₒₓ is the capacitance of a gate oxide layer on a unit area,

$$\frac{W}{L}$$

is the width-to-length ratio of the drive transistor M0, and the numerical values in the same structure are relatively stable and may be regarded as constants. The turn-on fifth switching transistor M5 turns on the second electrode D of the drive transistor M0 and the light emitting device L, so that the drive current I_{L} generated by the drive transistor M0 is provided to the light emitting device L in order to drive the light emitting device L to emit light. Known from the formula that the drive current I_{L} meets, the drive current I_{L}, for driving the light emitting device L to emit light, of the drive transistor M0 is only related to the voltage V_{data} of the data signal Data and the voltage V_{ref1} of the first reference signal line Vref1, but is unrelated to the threshold voltage Vₜₕ of the drive transistor M0 and the voltage V_{ref2} of the second reference signal line Vref2, and influences of threshold voltage Vₜₕ drifting and IR Drop caused by the technological processes and long-term operation of the drive transistor M0 on the drive current IL for driving the light emitting device L may be overcome, so that the drive current I_{L} for the light emitting device L is kept stable, and furthermore, the normal work of the light emitting device L is guaranteed.

During the reset phase, the voltages of the gate electrode and the second electrode of the drive transistor respectively become V_{ref1}, the voltage of the first electrode of the drive transistor becomes V_{ref2}, so that the three electrodes of the drive transistor may be simultaneously reset. During the threshold compensation phase, the voltages of the gate electrode and the second electrode of the drive transistor are respectively enabled to be V_{ref1}, and the voltage of the first electrode of the drive transistor is enabled to become V_{ref1}-Vₜₕ, namely before the phase that each frame data is written, the gate electrode of the drive transistor may have the fixed voltage V_{ref1}, the first electrode of the drive transistor may have the fixed voltage V_{ref1}-Vₜₕ, and the second electrode of the drive transistor may have the fixed voltage V_{ref1}. Therefore, when the data signal is written every time, the gate electrode of the drive transistor may be jumped by the same fixed voltage, the voltage of the first electrode of the drive transistor may be jumped by the same fixed voltage, and furthermore, the short-term residual image problem caused by the hysteresis effect may be relieved.

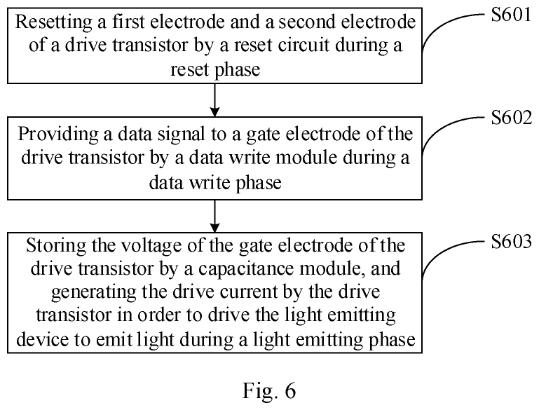

Based on the same inventive concept, some embodiments of the disclosure further provide a drive method of the pixel circuit provided by some embodiments of the disclosure, as shown in FIG. 6, including:

S601, resetting the first electrode and the second electrode of the drive transistor by the reset circuit during the reset phase;

S602, providing the data signal to the gate electrode of the drive transistor by the data write circuit during the data write phase;

and S603, storing the voltage of the gate electrode of the drive transistor by the capacitance circuit, and generating the drive current by the drive transistor in order to drive the light emitting device to emit light during the light emitting phase.

According to the drive method provided by some embodiments of the disclosure, the first electrode and the second electrode of the drive transistor may be reset by the reset circuit during the reset phase, then, the data signal may be written into the gate electrode of the drive transistor by the data write circuit, and the drive current is generated by the drive transistor in order to drive the light emitting device to emit light. Thus, the voltage of the first electrode of the drive transistor may be set as the fixed voltage before the data signal is written every time, and the voltage of the second electrode of the drive transistor may be set as the fixed voltage, so that influences of the residual voltage of the previous frame on the light emission of the frame may be avoided, and furthermore, the light emitting uniformity of the display panel may be improved.

During specific implementation, the drive method provided by some embodiments of the disclosure may further include: resetting the gate electrode of the drive transistor by the reset circuit during the reset phase.

Moreover, after the reset phase and before the data write phase, the method provided by some embodiments of the disclosure may further include: compensating the threshold voltage of the drive transistor by the reset circuit during the threshold compensation phase.

During specific implementation, when the reset circuit includes the first switching transistor, the second switching transistor and the third switching transistor, in the drive method provided by some embodiments of the disclosure, during the reset phase, the first switching transistor in the reset circuit is controlled to be turned on and the signal of the first reference signal line is controlled to be provided to the second electrode of the drive transistor, the second switching transistor is controlled to be turned on and the signal of the second reference signal line is controlled to be provided to the first electrode of the drive transistor, the third switching transistor is controlled to be turned on and the signal of the third reference signal line is controlled to be provided to the gate electrode of the drive transistor.

Moreover, during the threshold compensation phase, the second switching transistor in the reset circuit is controlled to be turned off, the first switching transistor is controlled to be turned on and the signal of the first reference signal line is controlled to be provided to the second electrode of the drive transistor, the third switching transistor is controlled to be turned on and the signal of the third reference signal line is controlled to be provided to the gate electrode of the drive transistor; and the drive transistor is turned on to perform threshold compensation.

During specific implementation, the drive method provided by some embodiments of the disclosure may further include: turning on the second electrode of the drive transistor and the first electrode of the light emitting device by the light emitting control circuit during the reset phase and the light emitting phase.

During specific implementation, due to the effects of the reset phase, the threshold compensation phase, the data write phase and the light emitting phase, the drive current, for driving the light emitting device to emit light, of the drive transistor may be only related to the voltage of the data signal and the voltage of the signal of the first reference signal line, but may be unrelated to the threshold voltage of the drive transistor and the voltage of the signal of the second reference signal line, and influences of the threshold voltage of the drive transistor and the IR Drop of the second reference signal line on the drive current flowing through the light emitting device may be avoided, so that the working current for driving the light emitting device to emit light is kept stable, and furthermore, the brightness uniformity of a display frame in the display panel may be improved.

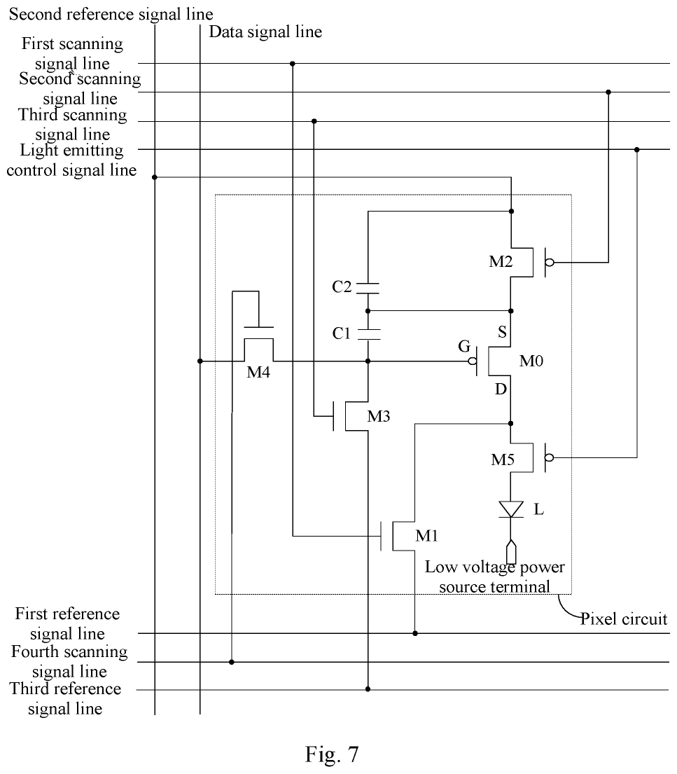

Based on the same inventive concept, some embodiments of the disclosure further provide an electroluminescent light emitting display panel, as shown in FIG. 7, including a pixel circuit (PX), a data signal line DATA, a first scanning signal line Scan1, a second scanning signal line Scan2, a third scanning signal line Scan3, a fourth scanning signal line Scan4, a light emitting control signal line EMIT, a first reference signal line Vref1, a second reference signal line Vref2 and a third reference signal line Vref3;

the pixel circuit PX may include a first switching transistor M1, a second switching transistor M2, a third switching transistor M3, a fourth switching transistor M4, a fifth switching transistor M5, a drive transistor M0, a storage capacitor C1, a voltage dividing capacitor C2 and a light emitting device L; wherein

a gate electrode of the first switching transistor M1 is coupled to the first scanning signal line Scan1 applying the current corresponding signal to the gate electrode of the first switching transistor M1, a first electrode of the first switching transistor M1 is coupled to the first reference signal line Vref1, and a second electrode of the first switching transistor M1 is coupled to a second electrode D of the drive transistor M0;

a gate electrode of the second switching transistor M2 is coupled to the second scanning signal line Scan2 applying the current corresponding signal to the gate electrode of the second switching transistor M2, a first electrode of the second switching transistor M2 is coupled to the second reference signal line Vref2, and a second electrode of the second switching transistor M2 is coupled to a first electrode S of the drive transistor M0;

a gate electrode of the third switching transistor M3 is coupled to the third scanning signal line Scan3 applying the current corresponding signal to the gate electrode of the third switching transistor M3, a first electrode of the third switching transistor M3 is coupled to the third reference signal line Vref3, and a second electrode of the third switching transistor M3 is coupled to a gate electrode G of the drive transistor M0;

a gate electrode of the fourth switching transistor M4 is coupled to the fourth scanning signal line Scan4 applying the current corresponding signal to the gate electrode of the fourth switching transistor M4, a first electrode of the fourth switching transistor M4 is coupled to the data signal line DATA applying the current corresponding signal to the first electrode of the fourth switching transistor M4, and a second electrode of the fourth switching transistor M4 is coupled to the gate electrode G of the drive transistor M0;

a gate electrode of the fifth switching transistor M5 is coupled to the light emitting control signal line EMIT applying the current corresponding signal to the gate electrode of the fifth switching transistor M5, a first electrode of the fifth switching transistor M5 is respectively coupled to the second electrode D of the drive transistor M0 and the second electrode of the first switching transistor M1, and a second electrode of the fifth switching transistor M5 is coupled to a first electrode of the light emitting device L;

the storage capacitor C1 is coupled between the gate electrode G and the first electrode S of the drive transistor M0;

and the voltage dividing capacitor C2 is coupled between the first electrode S of the drive transistor M0 and the second reference signal line Vref2.

According to the electroluminescent light emitting display panel provided by some embodiments of the disclosure, the corresponding signal is input by each signal line, so that the first switching transistor, the second switching transistor, the third switching transistor, the fourth switching transistor, the fifth switching transistor, the drive transistor, the storage capacitor, the voltage dividing capacitor and the light emitting device in the pixel circuit are controlled to mutually cooperate, so that the light emitting display of the electroluminescent light emitting display panel may be realized.

During specific implementation, the electroluminescent light emitting display panel provided by some embodiments of the disclosure may further include a gate electrode drive circuit; wherein corresponding gate electrode scanning signals are provided to the first scanning signal line, the second scanning signal line, the third scanning signal line and the fourth scanning signal line by the gate electrode drive circuit.

During specific implementation, the electroluminescent light emitting display panel provided by some embodiments of the disclosure may further include a light emitting control circuit; wherein a corresponding light emitting control signal is provided to the light emitting control signal line by the light emitting control circuit.

During specific implementation, the electroluminescent light emitting display panel provided by some embodiments of the disclosure may further include a source electrode drive circuit; wherein a corresponding data signal is provided to the data signal line by the source electrode drive circuit.

During specific implementation, the working process of the pixel circuit in the electroluminescent light emitting display panel provided by some embodiments of the disclosure may refer to the implementation of the pixel circuit, and the descriptions thereof are omitted herein.

During specific implementation, the electroluminescent light emitting display panel provided by some embodiments of the disclosure is capable of guaranteeing display uniformity when performing display by reducing the refresh frequency by combining the two processes for preparing the transistors including the LTPS-type transistors and the oxide thin film transistors.

During specific implementation, in the electroluminescent light emitting display panel provided by some embodiments of the disclosure, the data signal line and the second reference signal line may be respectively made of the same material and arranged on the same layer with the first electrodes and the second electrodes of the switching transistors in the pixel circuit; moreover, the first scanning signal line, the second scanning signal line, the third scanning signal line, the fourth scanning signal line, the light emitting control signal line, the first reference signal line and the third reference signal line may be respectively made of the same material and arranged on the same layer with the gate electrodes of the switching transistors in the pixel circuit. Thus, patterns of the data signal line, the second reference signal line as well as the first electrodes and the second electrodes of the switching transistors in the pixel circuit may be simultaneously formed by adopting a primary patterning process, and patterns of all scanning signal lines, the first reference signal line, the third reference signal line, the light emitting control signal line as well as the gate electrodes of the switching transistors in the pixel circuit may be simultaneously formed by adopting another primary patterning process, so that the preparation process may be simplified, and the thickness of the electroluminescent light emitting display panel may be reduced.

During specific implementation, when the data signal line and the second reference signal line as well as the first electrodes and the second electrodes of the switching transistors in the pixel circuit are made of the same material and are arranged on the same layer, in the electroluminescent light emitting display panel provided by some embodiments of the disclosure, the data signal line may extend in a column direction of pixel units formed by the pixel circuit, and the second reference signal line extends in the column direction of the pixel units. Of course, the second reference signal line may also be arranged in the electroluminescent light emitting display panel by adopting a grid structure.

During specific implementation, when all scanning signal lines, all reference signal lines, the light emitting control signal line and the gate electrodes of the switching transistors in the pixel circuit are made of the same material and arranged on the same layer, in the electroluminescent light emitting display panel provided by some embodiments of the disclosure, all scanning signal lines, the first reference signal line, the third reference signal line and the light emitting control signal line may extend in a row direction of the pixel units. Moreover, since a gap between two adjacent rows of pixel units is generally larger than that of two adjacent columns of pixel units, the layout design of the electroluminescent light emitting display panel may be further optimized by respectively enabling all reference signal lines towards the row direction of the pixel units.

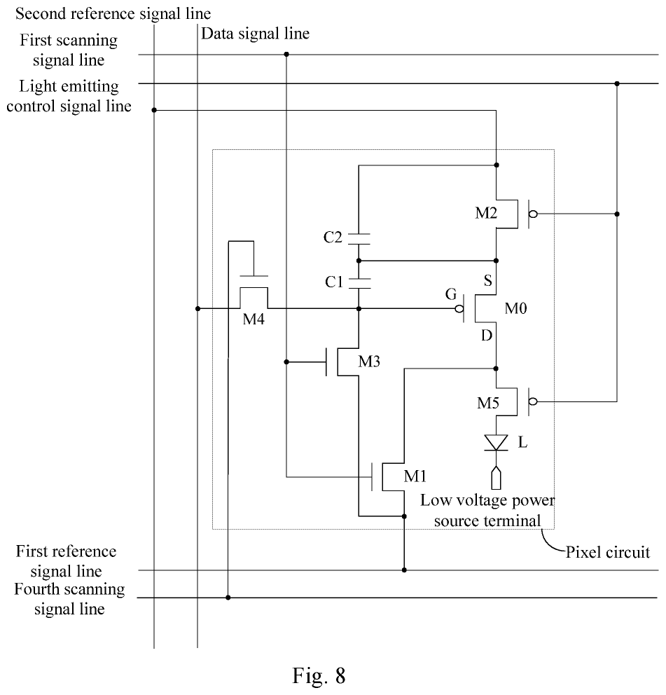

In order to reduce the arrangment of the signal lines and save the line arrangment space, during specific implementation, in the electroluminescent light emitting display panel provided by some embodiments of the disclosure, the signals of the first scanning signal line and the third scanning signal line coupled to the same pixel circuit may be set to be the same. Alternatively, the first scanning signal line and the third scanning signal line coupled to the same pixel circuit are enabled to be set as the same signal line. Optionally, as shown in FIG. 8, both the gate electrode of the first switching transistor M1 and the gate electrode of the third switching transistor M3 are coupled to the first scanning signal line Scan1.

In order to reduce the arrangment of the signal lines and save the line arrangment space, during specific implementation, in the electroluminescent light emitting display panel provided by some embodiments of the disclosure, the signals of the light emitting control signal line and the second scanning signal line coupled to the same pixel circuit may be set to be the same. Alternatively, the light emitting control signal line and the second scanning signal line coupled to the same pixel circuit are enabled to be set as the same signal line. Thus, the layout design of the electroluminescent light emitting display panel may be further optimized. Specifically, as shown in FIG. 8, both the second switching transistor M2 and the fifth switching transistor M5 are coupled to the light emitting control signal line EMIT.

In order to reduce the arrangment of the signal lines and save the line arrangment space, during specific implementation, in the electroluminescent light emitting display panel provided by some embodiments of the disclosure, the signal of the first reference signal line and the signal of the third reference signal line may be set to be the same. Alternatively, the first reference signal line and the third reference signal line are enabled to be also set as the same signal line. Thus, the layout design of the electroluminescent light emitting display panel may be further optimized. Optionally, as shown in FIG. 8, both the first switching transistor M1 and the third switching transistor M3 are coupled to the first reference signal line Vref1.

The cathode of the light emitting device in the electroluminescent light emitting display panel provided by some embodiments of the disclosure may be the same as the design in the prior art, for example, the cathode may be designed to be a one-whole-side cathode layer, the descriptions thereof are omitted herein.

During specific implementation, the electroluminescent light emitting display panel provided by some embodiments of the disclosure may be an organic light emitting display panel or a quantum dot light emitting display panel, but is not limited herein.

Based on the same inventive concept, some embodiments of the disclosure further provide a display apparatus including the electroluminescent light emitting display panel provided by some embodiments of the disclosure. The display apparatus may be any product or component with a display function, such as a mobile phone, a tablet personal computer, a display, a notebook computer, a digital photo frame and a navigator. Other essential components of the display apparatus should be understood to be provided by the ordinary skilled in the art, the descriptions thereof are omitted herein, and the components should not be regarded as limits to the disclosure. The implementation of the display apparatus may refer to some embodiments of the pixel circuit, the descriptions thereof are omitted herein.

According to the pixel circuit, the drive method, the electroluminescent light emitting display panel, and the display apparatus provided by some embodiments of the disclosure, the first electrode and the second electrode of the drive transistor may be reset by the reset circuit during the reset phase, then, the data signal may be written into the gate electrode of the drive transistor by the data write circuit, and the drive current is generated by the drive transistor in order to drive the light emitting device to emit light. Thus, the voltage of the first electrode of the drive transistor may be set as a fixed voltage before the data signal is written every time, and the voltage of the second electrode of the drive transistor may be set as the fixed voltage, so that influences of the residual voltage of the previous frame on the light emission of the frame may be avoided, and furthermore, the light emitting uniformity of the display panel may be improved.

Although the preferred embodiments of the disclosure have been described, the embodiments may be further altered and modified once the basic creative concept is known by the skilled in the art. Therefore, appended claims intend to be explained to include the preferred embodiments and all alterations and modifications falling into the scope of the disclosure.

It is apparent that various alternations and modifications of some embodiments of the disclosure may be made without departing from the spirit and scope of some embodiments of the disclosure by the skilled in the art. Thus, if the alterations and modifications of some embodiments of the disclosure fall into the claims of the disclosure and the equivalent technical scope thereof, the disclosure also intends to include the alterations and modifications.

1. A pixel circuit, comprising:
a light emitting device;
a drive transistor, configured to generate a drive current during a light emitting phase in order to drive the light emitting device to emit light; wherein a gate electrode of the drive transistor is respectively coupled to a capacitance circuit and a data write circuit, a first electrode of the drive transistor is coupled to a reset circuit, and a second electrode of the drive transistor is respectively coupled to the reset circuit and a first electrode of the light emitting device;
the capacitance circuit, configured to store a voltage of the gate electrode of the drive transistor;
the data write circuit, configured to provide a data signal to the gate electrode of the drive transistor during a data write phase;
and the reset circuit, configured to reset the first electrode and the second electrode of the drive transistor during a reset phase.

2. The pixel circuit according to claim 1, wherein the reset circuit is further coupled to the gate electrode of the drive transistor, is configured to reset the gate electrode of the drive transistor during the reset phase and is configured to compensate a threshold voltage of the drive transistor during a threshold compensation phase;
wherein the reset circuit comprises a first switching transistor, a second switching transistor and a third switching transistor;
a gate electrode of the first switching transistor is coupled to a first scanning signal line, a first electrode of the first switching transistor is coupled to a first reference signal line, and a second electrode of the first switching transistor is coupled to the second electrode of the drive transistor;
a gate electrode of the second switching transistor is coupled to a second scanning signal line, a first electrode of the second switching transistor is coupled to a second reference signal line, and a second electrode of the second switching transistor is coupled to the first electrode of the drive transistor;
and a gate electrode of the third switching transistor is coupled to a third scanning signal line, a first electrode of the third switching transistor is coupled to a third reference signal line, and a second electrode of the third switching transistor is coupled to the gate electrode of the drive transistor.

3. (canceled)

4. The pixel circuit according to claim 32, wherein materials of active layers of the first switching transistor and the third switching transistor comprise a metal oxide semiconductor material;
and a material of an active layer of the second switching transistor comprises a low temperature poly-silicon material.

5. The pixel circuit according to claim 2, wherein a signal of the first scanning signal line is same as a signal of the third scanning signal line, or a signal of the first reference signal line is same as a signal of the third reference signal line.

6. (canceled)

7. The pixel circuit according to claim 1, wherein the capacitance circuit comprises a storage capacitor and a voltage dividing capacitor:
the storage capacitor is coupled between the gate electrode and the first electrode of the drive transistor;
and the voltage dividing capacitor is coupled between the first electrode of the drive transistor and the second reference signal line.

8. The pixel circuit according to claim 1, wherein the data write circuit comprises a fourth switching transistor;
a gate electrode of the fourth switching transistor is coupled to a fourth scanning signal line, a first electrode of the fourth switching transistor is coupled to a data signal line and is configured to receive a data signal, and a second electrode of the fourth switching transistor is coupled to the gate electrode of the drive transistor.

9. The pixel circuit according to claim 8, wherein a material of an active layer of the fourth switching transistor comprises a metal oxide semiconductor material.

10. The pixel circuit according to claim 1, further comprising a light emitting control circuit; the second electrode of the drive transistor and the reset circuit being respectively coupled to the first electrode of the light emitting device by the light emitting control circuit;
wherein the light emitting control circuit is configured to control the second electrode of the drive transistor and the first electrode of the light emitting device to be turned on or off.

11. The pixel circuit according to claim 10, wherein the light emitting control circuit comprises a fifth switching transistor;
a gate electrode of the fifth switching transistor is coupled to a light emitting control signal line, a first electrode of the fifth switching transistor is coupled to the second electrode of the drive transistor, and a second electrode of the fifth switching transistor is coupled to the first electrode of the light emitting device.

12. The pixel circuit according to claim 11, wherein a material of an active layer of the fifth switching transistor comprises a low temperature poly-silicon material, a material of an active layer of the drive transistor comprises a low temperature poly-silicon material;
wherein a signal of the light emitting control signal line is same as a signal of the second scanning signal line.

13. (canceled)

14. (canceled)

15. A pixel circuit, comprising:
a light emitting device;
a first switching transistor, a gate electrode of the first switching transistor being coupled to a first scanning signal line, a first electrode of the first switching transistor being coupled to a first reference signal line, and a second electrode of the first switching transistor being coupled to a second electrode of a drive transistor;
a second switching transistor, a gate electrode of the second switching transistor being coupled to a second scanning signal line, a first electrode of the second switching transistor being coupled to a second reference signal line, and a second electrode of the second switching transistor being coupled to a first electrode of the drive transistor;
a third switching transistor, a gate electrode of the third switching transistor being coupled to a third scanning signal line, a first electrode of the third switching transistor being coupled to a third reference signal line, and a second electrode of the third switching transistor being coupled to a gate electrode of the drive transistor;
a fourth switching transistor, a gate electrode of the fourth switching transistor being coupled to a fourth scanning signal line, a first electrode of the fourth switching transistor being coupled to a data signal line, and a second electrode of the fourth switching transistor being coupled to the gate electrode of the drive transistor;
a fifth switching transistor, a gate electrode of the fifth switching transistor being coupled to a light emitting control signal line, a first electrode of the fifth switching transistor being respectively coupled to the second electrode of the drive transistor and the second electrode of the first switching transistor, and a second electrode of the fifth switching transistor being coupled to a first electrode of the light emitting device;
a storage capacitor, the storage capacitor being coupled between the gate electrode and the first electrode of the drive transistor;
and a voltage dividing capacitor, the voltage dividing capacitor being coupled between the first electrode of the drive transistor and the second reference signal line.

16. The pixel circuit according to claim 15, wherein materials of active layers of the first switching transistor, the third switching transistor and the fourth switching transistor comprise a metal oxide semiconductor material;
and materials of active layers of the second switching transistor, the fifth switching transistor and the drive transistor comprise a low temperature poly-silicon material.

17. The pixel circuit according to claim 15, wherein a signal of the first scanning signal line is same as a signal of the third scanning signal line, or a signal of the first reference signal line is same as a signal of the third reference signal line, or a signal of the light emitting control signal line is same as a signal of the second scanning signal line.

18. (canceled)

19. (canceled)

20. An electroluminescent light emitting display panel, comprising a pixel circuit, a data signal line, a first scanning signal line, a second scanning signal line, a third scanning signal line, a fourth scanning signal line, a light emitting control signal line, a first reference signal line, a second reference signal line and a third reference signal line;
the pixel circuit comprising a first switching transistor, a second switching transistor, a third switching transistor, a fourth switching transistor, a fifth switching transistor, a drive transistor, a storage capacitor, a voltage dividing capacitor and a light emitting device; wherein a gate electrode of the first switching transistor is coupled to the first scanning signal line applying the current corresponding signal to the gate electrode of the first switching transistor, a first electrode of the first switching transistor is coupled to the first reference signal line, and a second electrode of the first switching transistor is coupled to the second electrode of the drive transistor;
a gate electrode of the second switching transistor is coupled to the second scanning signal line applying the current corresponding signal to the gate electrode of the second switching transistor, a first electrode of the second switching transistor is coupled to the second reference signal line, and a second electrode of the second switching transistor is coupled to a first electrode of the drive transistor;
a gate electrode of the third switching transistor is coupled to the third scanning signal line applying the current corresponding signal to the gate electrode of the third switching transistor, a first electrode of the third switching transistor is coupled to the third reference signal line, and a second electrode of the third switching transistor is coupled to a gate electrode of the drive transistor;
a gate electrode of the fourth switching transistor is coupled to the fourth scanning signal line applying the current corresponding signal to the gate electrode of the fourth switching transistor, a first electrode of the fourth switching transistor is coupled to the data signal line applying the current corresponding signal to the first electrode of the fourth switching transistor, and a second electrode of the fourth switching transistor is coupled to the gate electrode of the drive transistor;
a gate electrode of the fifth switching transistor is coupled to the light emitting control signal line applying the current corresponding signal to the gate electrode of the fifth switching transistor, a first electrode of the fifth switching transistor is respectively coupled to the second electrode of the drive transistor and the second electrode of the first switching transistor, and a second electrode of the fifth switching transistor is coupled to a first electrode of the light emitting device;
the storage capacitor is coupled between the gate electrode and the first electrode of the drive transistor;
and the voltage dividing capacitor is coupled between the first electrode of the drive transistor and the second reference signal line.

21. The electroluminescent light emitting display panel according to claim 20, wherein signals of the first scanning signal line and the third scanning signal line coupled to a same pixel circuit are same, or
a signal of the first reference signal line is same as a signal of the third reference signal line, or signals of the light emitting control signal line and the second scanning signal line coupled to a same pixel circuit are same.

22. (canceled)

23. (canceled)

24. A display apparatus, comprising the electroluminescent light emitting display panel according to claim 20.

25. A drive method of the pixel circuit according to claim 1, comprising:
resetting the first electrode and the second electrode of the drive transistor by the reset circuit during a reset phase;
providing the data signal to the gate electrode of the drive transistor by the data write circuit during a data write phase;
and storing the voltage of the gate electrode of the drive transistor by the capacitance circuit, and generating the drive current by the drive transistor in order to drive the light emitting device to emit light during a light emitting phase.

26. The method according to claim 25, further comprising: resetting the gate electrode of the drive transistor by the reset circuit during the reset phase;
and after the reset phase and before the data write phase, the method further comprising:
compensating the threshold voltage of the drive transistor by the reset circuit during a threshold compensation phase.

27. The method according to claim 26, wherein during the reset phase, the first switching transistor in the reset circuit is controlled to be turned on and the signal of the first reference signal line is controlled to be provided to the second electrode of the drive transistor, the second switching transistor is controlled to be turned on and the signal of the second reference signal line is controlled to be provided to the first electrode of the drive transistor, the third switching transistor is controlled to be turned on and the signal of the third reference signal line is controlled to be provided to the gate electrode of the drive transistor;
and during the threshold compensation phase, the second switching transistor in the reset circuit is controlled to be turned off, the first switching transistor is controlled to be turned on and the signal of the first reference signal line is controlled to be provided to the second electrode of the drive transistor, the third switching transistor is controlled to be turned on and the signal of the third reference signal line is controlled to be provided to the gate electrode of the drive transistor; and the drive transistor is turned on to perform threshold compensation.

28. The method according to claim 25, further comprising: turning on the second electrode of the drive transistor and the first electrode of the light emitting device by the light emitting control circuit during the reset phase and the light emitting phase.
